(19) United States
(12) Patent Application Publication
(10) Pub. No.: US 2011/0191157 A1
(43) Pub. Date: Aug. 4, 2011

(54) INTEGRATED MERCHANT OFFER PROGRAM AND CUSTOMER SHOPPING

(75) Inventors: Jason Blackhurst, Charlotte, NC (US); Michael W. Upton, Charlotte, NC (US)

(73) Assignee: BANK OF AMERICA CORPORATION, Charlotte, NC (US)

(21) Appl. No.: 13/013,720

(22) Filed: Jan. 25, 2011

Related U.S. Application Data
(60) Provisional application No. 61/299,651, filed on Jan. 29, 2010.

(51) Int. Cl. G06Q 30/00

(52) U.S. Cl. 705/14.25

(57) ABSTRACT

Embodiments of the invention include a merchant offer program application, which is downloaded onto a customer computer, and that works in connection with the customer's accounts at an institution. The merchant offer program application monitors the websites that the customer views, as well as the content the customer is viewing on those websites, such as the products offered for sale through the website or other information on the website. The merchant offer program provides additional information to the customer, such as special offers that are available for the product being viewed, the identity of other merchants that offer the product or a competing product, advertisements or offers regarding other ancillary products typically sold along with the product being considered, etc. The information sent to the customer can be based not only on the website product being viewed, but on the customer's past purchase behavior, account balances, interests, etc.

### CLAIM OF PRIORITY UNDER 35 U.S.C. §119

The present application for a patent claims priority to Provisional Application No. 61/299,651 entitled “Integrated Online Financial Payment and Customer Shopping” filed Jan. 29^{th}, 2010 and assigned to the assignees hereof and hereby expressly incorporated by reference herein.

### FIELD

This invention relates generally to customized offers (i.e. discounts), product content, or other information about goods or services in which consumers have an interest, as well as available payment options for purchasing the goods or services. More particularly, embodiments of the invention relate to apparatuses and methods for an application that utilizes transactional data and browsing information to develop and provide offers (i.e. discounts), product content, or other information that is customized based on the information about goods or services accessed by consumers and, further provides, for access to various sources of payment that each consumer has available to pay for any selected goods or services.

### BACKGROUND

The advent of the Internet has provided merchants with new channels for reaching customers and providing information, advertising, and offers related to their goods or services. However, sales and marketing campaigns are often not as effective as they might be because they provide the customer information, advertisements, or offers about which the customer is not interested, or alternatively provide the customer information, advertisements, or offers about which the customer is interested at the wrong time. The Internet, likewise, provides customers with the ability to quickly locate information about goods or services in which they are interested, and to purchase those goods or services without leaving their computer. However, customers who shop online often cannot find the exact good or service that they want, fail to find what they want at a price that they find attractive, or fail to utilize discounts that are available for the goods or services. These scenarios result in merchant discounts or promotions that are not being utilized, or in customers not receiving the benefit of such merchant discounts or promotions. There is a need to develop apparatuses and methods to facilitate merchants in providing targeted sales and marketing offers to customers, as well as to provide customers with payment options and information for making purchasing decisions for goods and services.

### BRIEF SUMMARY

Embodiments of the present invention address the above needs and/or achieve other advantages by providing apparatuses (e.g., a system, computer program product, and/or other device), methods, or a combination of the foregoing for a merchant offer program application that integrates merchant offers related to goods and/or services (hereinafter “products”) with customer shopping activities and sources of payment.

Financial institutions have large amounts of customer data because they maintain or administer various financial accounts (i.e. credit card account, checking account, savings account, etc.) of their customers and they store data related to purchases made by their customers. Financial institutions track and store data related to what products customers purchase, when their customers made the purchases, how much the customers spent, what merchants the customers used to make the purchases, etc. for both online and offline purchases. Furthermore, financial institutions also have direct ties with many different merchants, which use the financial institutions for their own financial needs. Due to the relationships financial institutions have with both customers and merchants, as well as the data that they capture because of those relationships, financial institutions are uniquely positioned to facilitate merchants in providing targeted sales and marketing offers to customers at the time of purchase, as well as to provide customers with payment options and information (i.e. balances) for making purchasing decisions for products.

Generally, one embodiment of the invention includes a merchant offer program application, which is downloaded onto a customer computer by the customer, and that works in connection with the customer's accounts at an institution. When the institution is a financial institution the merchant offer program is a financial-institution based merchant offer program that works in connection with the customer's financial accounts, such as the customer's online banking account. However, such a financial-institution based merchant offer program is described generally herein as the merchant offer program. The merchant offer program application runs on the customer's computer and monitors the websites that the customer views, as well as the content the customer is viewing on those websites, such as the products offered for sale through the website or other information on the website. Information about the websites, such as but not limited to products thereon, is relayed back to a central processor that locates information about the website, (i.e. products) and sends that information back to the customer. The information can include special offers that are available for the product being viewed, the identity of other merchants that offer the product or a competing product, advertisements or offers regarding other ancillary products typically sold along with the product being considered, etc. The information sent to the customer can be based not only on the website product being viewed, but on the customer's past purchase behavior, account balances, interests, etc. Offers that are communicated may be offers made available generally by the merchants, offers based on the institution's relationship with a merchant, etc.

Once a customer decides to make a purchase, the merchant offer program application can provide the customer with information about the customer's various accounts, including, but not limited to, account balances, credit limit remaining, etc. The customer can decide from the available options how to pay for the purchase. Moreover, inasmuch as the merchant offer program application is a financial-institution based merchant offer program that can run through a financial institution, funds can be transferred to the merchant on a real-time or near real-time basis.

The application can also provide the customer with information relating to warranties on the products purchased, affinity clubs that go along with the products, the opportunity to rate any products, services, or merchants, the ability to social network with others who have an interest in the purchased or considered products, etc.

Embodiments of the invention comprise systems, method, and/or computer program products for providing merchant offers, wherein the invention comprises receiving content information related to content in which a customer is interested; accessing account information for the customer from a customer account at an institution; determining an offer for the customer based at least in part on the content information received and the account information from the institution; and providing the offer to the customer at a customer computer system.

In further accord with embodiments of the invention, the content information related to content in which the customer is interested is content that the customer is viewing over the Internet. In another embodiment of the invention, the content information is related to a good or a service provided by a merchant. In yet another embodiment of the invention, the offer is for a discount, a coupon, a promotion, an add-on sale, an upsell, a rebate, an advertisement, or marketing information related to the content in which the customer is interested.

In still another embodiment of the invention, the account information comprises customer transaction information from the institution. In further accord with an embodiment of the invention, the account information comprises customer profile information from the institution. In another embodiment of the invention, the account information comprises relationship information between the customer and the institution. In yet another embodiment of the invention, the account information comprises relationship information between the customer and a merchant providing the product associated with the offer.

In still another embodiment of the invention, wherein determining an offer for the customer is also based at least in part on relationship information between the institution and a merchant providing the product associated with the offer.

In further accord with an embodiment of the invention, the invention further comprises receiving notification from the customer that the customer is interested in the offer.

In another embodiment of the invention, the invention further comprises display the offer on an interface at the customer computer system.

In yet another embodiment of the invention, the invention further comprises displaying at least one account balance on an interface at the customer computer system for the customer account.

In still another embodiment of the invention, the invention further comprises receive a selection of the offer indicating that the customer wants to enter into a transaction.

In further accord with an embodiment of the invention, the invention comprises receiving a selection of the customer account that the customer wants to use to make a transaction related to the offer.

In another embodiment of the invention, the institution is a financial institution. In still another embodiment of the invention, the invention is a merchant offer program application. In further accord with an embodiment of the invention, at least a portion of the merchant offer program application is stored in a first memory device associated with the institution, and the processing device configured to execute the merchant offer program application stored in the first memory device associated with the institution is a first processing device associated with the institution. In further accord with an embodiment of the invention, at least a portion of the merchant offer program application is stored in a second memory device associated with the customer computer system, and the processing device configured to execute the computer-readable program code of the portion of the merchant offer program application stored in the second memory device associated with the customer computer system is a second processing device associated with the customer computer system.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 provides a block diagram illustrating a merchant offer program environment, in accordance with an embodiment of the present invention;

FIG. 2A provides an integrated banking and customer shopping process, in accordance with an embodiment of the present invention;

FIG. 2B provides a continuation of the integrated banking and customer shopping process, in accordance with an embodiment of the present invention;

FIG. 3 provides a web browser and merchant offer program notification alert, in accordance with an embodiment of the present invention;

FIG. 4 provides a local merchant offer program application interface, in accordance with an embodiment of the present invention;

FIG. 5 provides a local merchant offer program application interface activated by a customer searching the Internet, in accordance with an embodiment of the present invention;

FIG. 6A provides an online banking account and customer shopping process in accordance with an embodiment of the present invention;

FIG. 6B provides a continuation of the online banking account and customer shopping process in accordance with an embodiment of the present invention;

FIG. 7 provides an online banking account detail transaction and offer interface in accordance with an embodiment of the present invention;

FIG. 8 provides an online banking account detail transaction and offer interface in accordance with an embodiment of the present invention; and

FIG. 9 provides an online banking account detail transaction and offer interface in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution. For instance, in some embodiments an entity that acts as a clearing house for offers could take the place of the financial institution in whole or in part throughout this application.

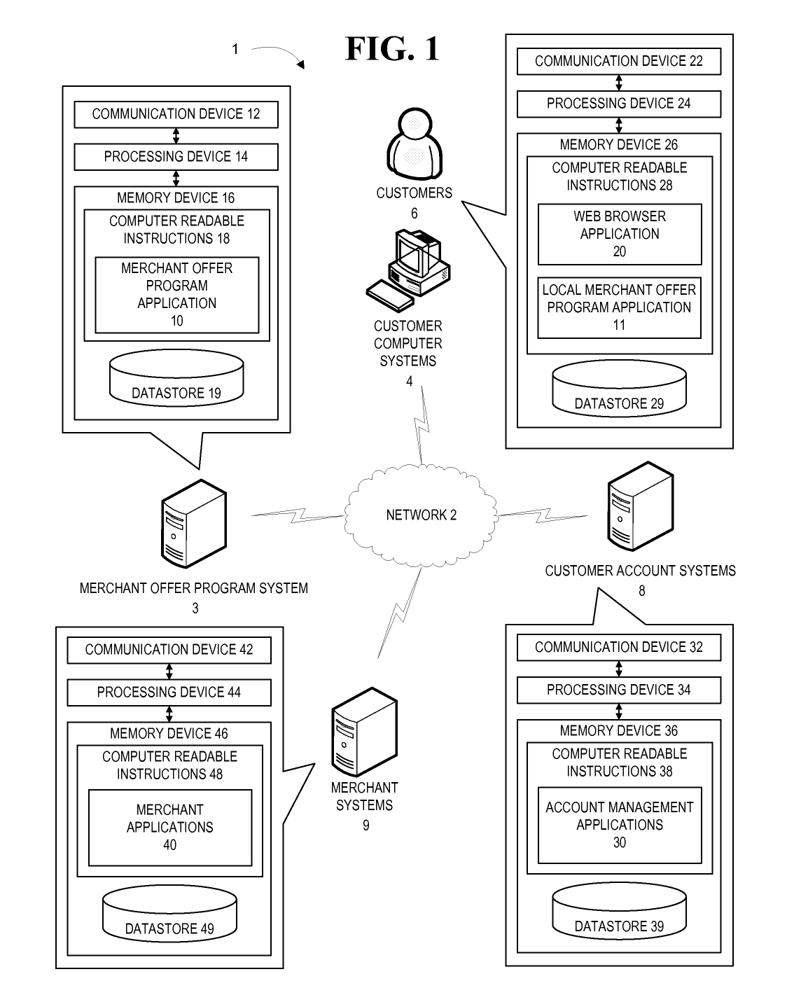

FIG. 1 illustrates a merchant offer program environment 1 in accordance with an embodiment of the present invention. As illustrated in FIG. 1, the financial institution's merchant offer program system 3 is operatively coupled, via a network 2, to one or more customer computer systems 4 of one or more customers 6, the financial institution's customer account systems 8, and the merchant systems 9, as well as other systems at a financial institution, such as systems that maintain and administer customer accounts, which are not shown. In this way, a customer 6 located at the customer computer system 4 can receive information from and send information to the merchant offer program application 10 located on the financial institution's merchant offer program system 3 through a local merchant offer program application 11 and/or a web browser application 20, located on the customer computer system 4 through the network 2.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices in the network. In some embodiments of the invention the network 2 described herein may be a cloud computing network. Therefore, systems outside of what are described herein may be utilized to run, store, pass data to, or receive data from at least a part of the merchant offer program application, local merchant offer program application, or some other application described herein.

As illustrated in FIG. 1, the financial institution's merchant offer program system 3 generally includes a communication device 12, a processing device 14, and a memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 is operatively coupled to the communication device 12, and the memory device 16. The processing device 14 uses the communication device 12 to communicate with the network 2, and other devices on the network 2, such as, but not limited to, the customer computer systems 4, the customer account systems 8, and/or the merchant systems 9, as well as other systems within the financial institution that are not shown. As such, the communication device 12 generally comprises a modem, server, or other device for communicating with other devices on the network 2.

As further illustrated in FIG. 1, the financial institution's merchant offer program system 3 includes computer-readable instructions 18 stored in the memory device 16, which in one embodiment includes the computer-readable instructions 18 of a merchant offer program application 10. In some embodiments, the memory device 16 includes a datastore 19 for storing data related to the financial institution's merchant offer program system 3, including but not limited to data created and/or used by the merchant offer program application 10.

As discussed later in greater detail, in one embodiment, the merchant offer program application 10 stores or receives customer profile data and data related to offline and online transactions from the account management applications 30. The merchant offer program application 10 receives data related to customer browsing behavior and returns targeted offers to the customer 6. Offers include but are not limited to products, services, discounts, coupons, promotions, add-on sales, upsells, rebates, advertisements, marketing information, etc.

As illustrated in FIG. 1, the customer computer systems 4 can include a communication device 22, a processing device 24, and a memory device 26. The processing device 24 is operatively coupled to the communication device 22 and the memory device 26. The processing device 24 uses the communication device 22 to communicate with the network 2, and other devices on the network 2, such as, but not limited to, the financial institution's merchant offer program system 3, customer account systems 8, and/or merchant systems 9, as well as other financial institution systems not shown. As such, the communication device 22 generally comprises a modem, server, or other device(s) for communicating with other devices on the network 2, and a display, keypad, mouse, keyboard, microphone, and/or speakers for communicating with one or more users. The customer computer systems 4 can be personal computers, personal digital assistants (“PDA”), smart phone, cell phones, etc.

As further illustrated in FIG. 1, the customer computer systems 4 comprise computer-readable program instructions 28 stored in the memory device 26, which in one embodiment includes the computer-readable instructions 28 of the local merchant offer program application 11 and a web browser application 20. In some embodiments, the memory device 26 includes a datastore 29 for storing data related to the customer computer systems 4, including but not limited to data created and/or used by the local merchant offer program application 11 and/or the web browser application 20.

In one embodiment of the invention, the local merchant offer program application 11 is the part of the merchant offer program application 10 that resides on the customer computer systems 4. The local merchant offer program application 11 assists in monitoring websites that the customer 6 is browsing through the web browser application 20 by monitoring and sending the information related to the customer's web browsing to the merchant offer program application 10. In other embodiments of the invention there is no local merchant offer program application 11, as such the merchant offer program application 10, which is located on the financial institution's databases, performs the functions of the local merchant offer program application 11 and, thus can interact directly with the web browser application 20 located on the customer computer systems 4. In other embodiments of the invention there is no local merchant offer program application 11, as such the merchant offer program application 10, which is located on the customer computer system 4, performs the functions of the local merchant offer program application 11. In still other embodiments of the invention the local merchant offer program application 11 is a separate application, which is located on the customer computer system 4, that works in conjunction with the merchant offer program application 10.

Throughout this patent the local merchant offer program application 11 is described as the part of the merchant offer program application 10 that resides on the customer computer systems 4; however, it is to be understood that the apparatuses and methods described herein would work equally well in the various embodiments of the merchant offer program application 10 and local merchant offer program application 11 described above. Regardless of the configuration, the local merchant offer program application 11 displays offers, determined by the merchant offer program application 10 related to what the customer is searching, to the customer 6 on an interactive graphical user interface (i.e. local interface 400). The offers can be, among other things, based in part on the data stored by the merchant offer program application 10 and the customer account systems 8, including but not limited to customer profile data and transaction history.

As illustrated in FIG. 1, the customer account systems 8 generally include a communication device 32, a processing device 34, and a memory device 36. The processing device 34 is operatively coupled to the communication device 32 and the memory device 36. The processing device 34 uses the communication device 32 to communicate with the network 2, and other devices on the network 2, such as, but not limited to, the merchant offer program system 3, the customer computer systems 4, and/or the merchant systems 9, as well as other systems at the financial institution not shown. As such, the communication device 32 generally comprises a modem, server, or other device(s) for communicating with other devices on the network 2.

As further illustrated in FIG. 1, the customer account systems 8 comprise computer-readable program instructions 38 stored in the memory device 36, which in one embodiment includes the computer-readable instructions 38 of account management applications 30. In some embodiments, the memory device 36 includes a datastore 39 for storing data related to the customer account systems 8, including but not limited to data created and/or used by the account management applications 30.

The account management applications 30, in one embodiment, are used to store, process, and monitor the transactions, including but not limited to, deposits, withdrawals, transfers, and payments, made through various customer accounts, such as, but not limited to, checking, savings, credit card, hybrid, deposit, credit line, money market, equity line, investment, bill payment, transfer, etc. accounts. The account management applications 30 have the transaction history information for each of the financial institution's customers, in some cases, for as long as the customers have had accounts with the bank. The transactions history information located in the account management applications is searchable and sortable over different ranges of time. The transaction information in the account management applications 30 is used by the merchant offer program application 10, along with other information or alone, to determine what targeted offers and marketing information should be sent to the customers 6. In some embodiments of the invention, the account management applications 30 include online banking applications, such as an online banking website, which allow a customer 6 to access the customer's accounts through the Internet.

As further illustrated in FIG. 1, the merchant systems 9 generally include a communication device 42, a processing device 44, and a memory device 46. The processing device 44 is operatively coupled to the communication device 42 and the memory device 46. The processing device 44 uses the communication device 42 to communicate with the network 2, and other devices on the network 2, such as, but not limited to, the merchant offer program system 3, customer computer systems 4, and/or customer account systems 8, as well as other systems at the financial institution not shown. As such, the communication device 42 generally comprises a modem, server, or other device(s) for communicating with other devices on the network 2, and a display, keypad, mouse, keyboard, microphone, and/or speakers for communicating with one or more users.

As further illustrated in FIG. 1, the merchant systems 9 comprise computer-readable program instructions 48 stored in the memory device 46, which in one embodiment includes the computer-readable instructions 48 of merchant applications 40. In some embodiments, the memory device 46 includes a datastore 49 for storing data related to the merchant systems 9, including but not limited to data created and/or used by the merchant applications 40.

The merchant applications 40, in one embodiment, are used to generate, store, process, and/or monitor the offers made directly to customer computer systems 4 over the network 2 or indirectly though the merchant offer program system 3.

In other embodiments of the invention, the merchant offer program environment 1 will include other systems in the financial institution that are connected over the network 2. In some embodiments of the invention, the other systems within the financial institution could include transaction processing systems such as check image processing, or online account processing systems. These other systems can work in conjunction with the merchant offer program system 3, or supplement and/or enhance the merchant offer program system 3.

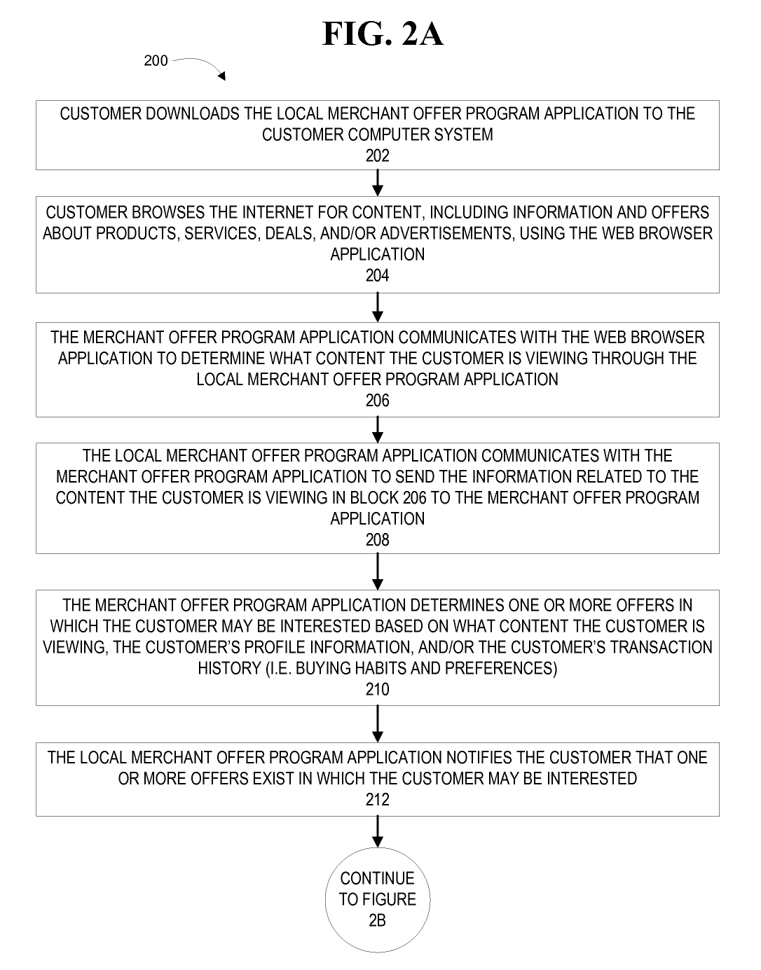

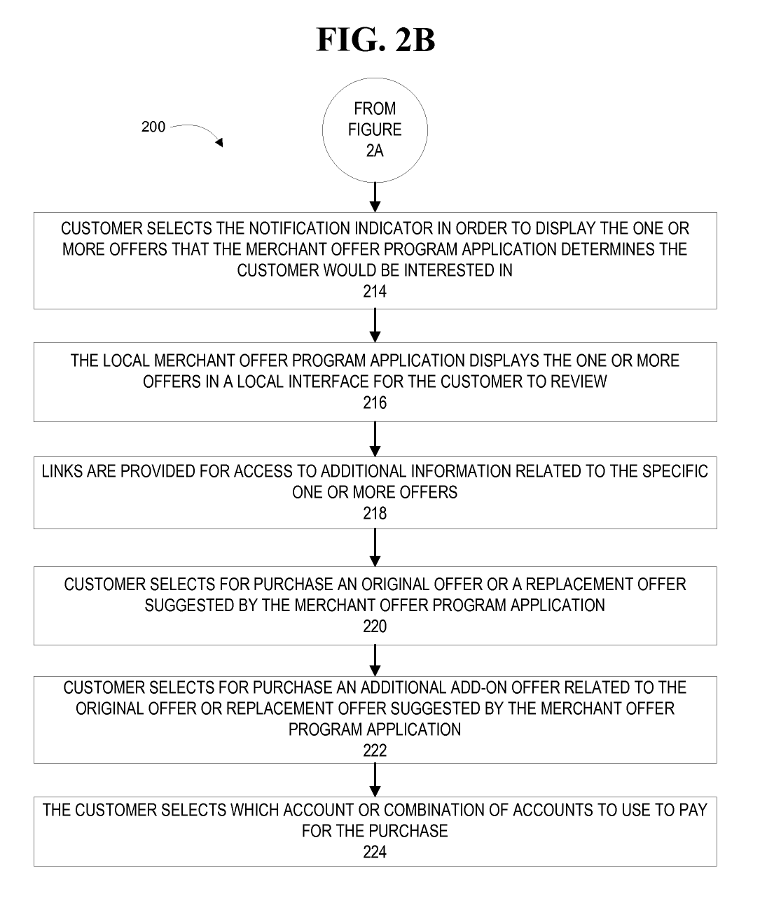

FIGS. 2A and 2B illustrate one embodiment of an integrated payment and customer shopping process 200 that describes how a customer 6 utilizes the merchant offer program environment 1 to search for offers on the Internet or in retail stores, receive offers related to the offers the customer 6 is searching, receive offers related to web-based content that the customer is accessing, and accept one or more of the offers using various forms of payment. In order to utilize the merchant offer program environment 1 the customer 6, in some embodiments, downloads the local merchant offer program application 11 to the customer computer system 4, as illustrated in block 202 of FIG. 2. In some embodiments the customer computer system 4 is a computer, such as a laptop, desktop, or tablet computer, Internet television, or other electronic or digital medium device, in other embodiments the customer computer system 4 may be a mobile device, such as a PDA, cell phone, smart phone, Internet-only computer, or any other device that has Internet browsing capability.

Once the local merchant offer program application 11 is downloaded to the customer computer system 4, in some embodiments it will run by communicating constantly with the merchant offer program application 10 located on the merchant offer program system 3. In other embodiments, the customer 6 has the ability to turn the merchant offer program application 10 on and off. In still other embodiments of the invention, the customer 6 will be required to authenticate herself as the customer before using the local merchant offer program application 11 and merchant offer program application 10. Authentication is required, in some embodiments, when the merchant offer program application 10 communicates with the customer's private customer account information located on the customer account systems 8 at the financial institution. As explained in greater detail below, the merchant offer program application 10 accesses the customer's account information in order to display to the customer 6, through the local merchant offer program application 11, the customer's balances for the accounts that the customer can use to pay for purchases made through the merchant offer program environment 1. Moreover, when the customer 6 makes a purchase through the merchant offer program application 10, the merchant offer program application 10 accesses the customer's account through the customer's online banking accounts and/or the customer account systems 8 in order to make real-time or near real-time transactions between the customer 6 and the merchant.

The customer 6 in some embodiments may perform the authentication when downloading the local merchant offer program application 11, when the customer 6 wants to use the local merchant offer program application 11, or only when the customer 6 decides to make a purchase. Generally, in exemplary embodiments, the local merchant offer program application 11 runs on the customer computer system 4 at all times, and the customer only authenticates herself when the customer wants to view the identified offers or purchase something through the offers supplied by the merchant offer program application 10.

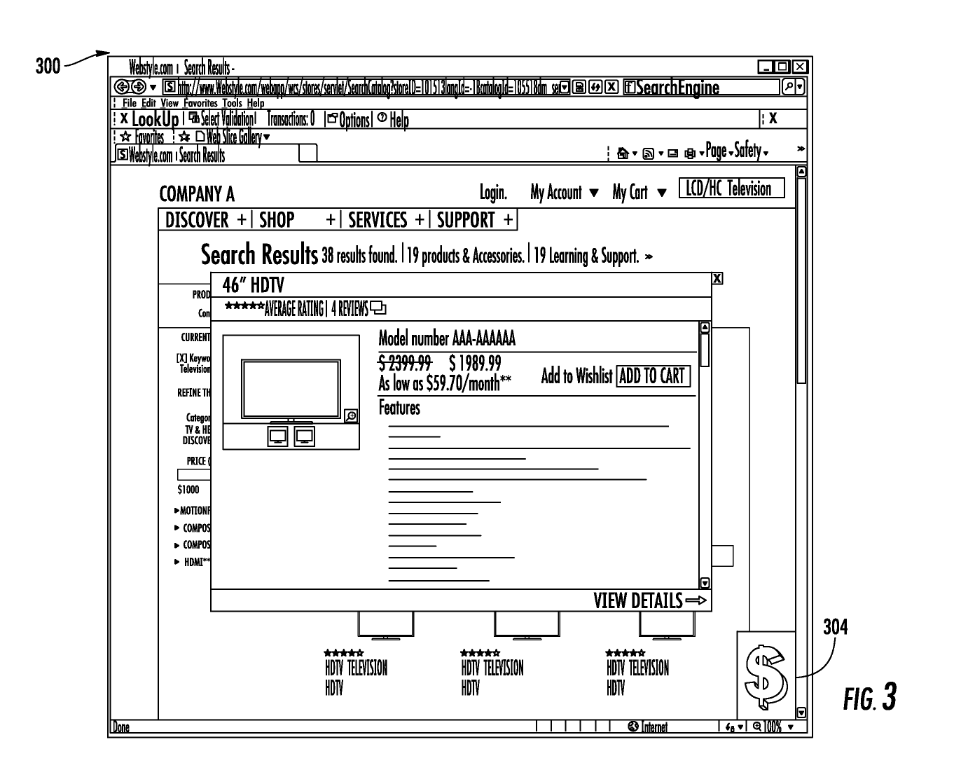

As illustrated in block 204 of FIG. 2A, the customer 6 searches the Internet for content, such as products or other information located on websites. For example, as illustrated in FIG. 3, the customer 6 may be searching for a forty-six inch LCD television made by Company A. Block 206 in FIG. 2A illustrates that as the customer 6 is searching for a particular product (i.e. the Company A TV), the merchant offer program application 10 communicates with the web browser application 20 that the customer is using, in order to determine what offers or other content the customer 6 is viewing through the web browser application 20. As illustrated in block 208 in FIG. 2A the local merchant offer program application 11 transfers the information related to the content the customer is viewing back to the merchant offer program application 10.

In some embodiments of the invention, the content the customer is viewing that is captured by the merchant offer program application 10, is not limited to content the customer is viewing through a web browser application 20 on a customer computer system 4. The content can be related to any digital channel to which the customer 6 has access, such as but not limited to interactive voice response (“IVR”) units, video being displayed on a television through a network, programs viewed by the customer on the television, content displayed by an automated teller machine (“ATM”), content displayed on electronic billboards, etc. The content used by the merchant offer program application 10, can be any content that the merchant offer program application can capture 10 through a digital medium. For example, the customer 6 may not even be able to visually view the content captured by the merchant offer program application through a digital medium.

In other embodiments of the invention, the customer 6 does not have to search the Internet for offers in order for the merchant offer program application 10 to gather information related to offers in which the customer 6 is interested. For example, if the local merchant offer program application 11 is downloaded on a mobile device, such as a PDA, cell phone, smart phone, etc., the local merchant offer program application 11 can relay information to the merchant offer program application 10 about the physical location of the customer through location determining devices, such as global positioning satellite (“GPS”) or radio frequency (“RF”) locator systems in the mobile device. The merchant offer program application 10 can then provide offers or information that are relevant to the customer's physical location, such as offers applicable to the store in which the customer is located, offers at other stores in close proximity, offers that can be purchased over the mobile device, etc.

In other embodiments of the invention, the customer 6 can use the mobile device to identify information related to an offer at a physical store. For example, information about a product can be captured by capturing an image of the product, scanning an identifier (i.e. barcode or UPC number) located on the product into the mobile device, and/or entering an identifier or keyword related to a product through a keyboard, touchscreen, or voice command. The merchant offer program application gathers the information related to the offer through the local merchant offer program application 11, which, as explained in greater detail below, provides the customer 6 with related offers or information on the customer's mobile device.

In some embodiments of the invention, a customer can use a mobile device to make a purchase through the actual point-of-sale applications at the store in which the customer is located. In some embodiments of the invention, a mobile device that is configured with a payment system, such as a near field communication (“NFC”) payment system or other payment system, can use the system to make a purchase through the local merchant offer program application 11 downloaded on the mobile device. The purchase, in some embodiments, takes into account real time discounts, e-Coupons, etc. available through the merchant offer program application 10, as discussed in further detail later. The customer's account can be updated in real-time or near real-time to reflect the most recent transactions using a mobile device for payment.

After receiving information related to what offers or other content the customer 6 is currently viewing or searching, in some embodiments, the merchant offer program application 10 analyzes the customer's past transaction purchasing history, and the customer's profile information to determine one or more offers to present to the customer 6 through the local merchant offer program application 11, as illustrated by block 210 in FIG. 2A. The merchant offer program application 10 analyzes the customer's past purchasing history and the customer's profile information, in part, from the account management applications 30, which store the histories of purchases made by the customer online and offline (i.e. brick and mortar stores).

In some embodiments of the invention, the financial institution may have a relationship with other financial institutions, credit card providers, Internet shopping services, etc., in order to gather more transactional data related to the customer's purchase history when the customer 6 makes transactions with other business accounts, credit cards, etc., in addition to the data that the financial institution maintains. In other embodiments the customer 6 can upload the transaction histories of transactions made with other financial institution accounts, credit cards, etc. by authorizing the financial institution to reach out and pull (or be pushed) data related to transactions from other accounts. For example, the customer 6 can provide the financial institution the account number and password to other online financial banking systems, online credit card statements, etc. and the financial institution can pull transaction information from those accounts. This additional information can be also be used to provide the customer 6 more payment options, from outside accounts, to use in completing the transaction.

In other embodiments of the invention the customer can log onto the customer's own merchant offer program account in the merchant offer program application 10, or other account management application 30 to provide or enter customized profile information. For example, the customer 6 can request specific types of offers, such as specific products, discounts, or advertisements in which the customer 6 is interested on a wish list, which is explained in further detail below. In other embodiments of the invention the customer 6 can provide profile information, which allows the merchant offer program application 10 to provide more personalized offers to each individual customer 6. For example, the profile information could include, but is not limited to, places the customer 6 likes to shop, hobbies in which the customer is interested, specific offers or merchants from whom the customer 6 does or does not want to receive offers from, etc.

The offers identified by the merchant offer program application 10 in block 210 and provided to the customer 6 through local merchant offer program application 11, are determined in a number of ways. In exemplary embodiments, the financial institution will have in place arrangements with merchants that allow the financial institution to provide certain products to customers through the merchant offer program application 10 at discounted prices. The financial institution will display the various products that are the subject of a discount coupon, rebate, reward, etc. The products will normally be displayed with the items carrying the greatest discount, coupon, rebate, reward, etc. first. The discount, coupon, rebate, reward, etc. can be the merchant's normal offer or can be the subject of a separate arrangement with the financial institution. In other embodiments, the merchant may pay a fee to the financial institution per month, week, etc., or a flat fee, etc., in exchange for the financial institution showing one or more of the merchant offers to customers 6. The size of discounts provided, and in some embodiments the fees paid by merchants, can be based on the number of hits the offer/website of the merchant receives, the number times the offer is displayed, the number of customers who accept the offer by making a purchase, and/or the rank of the offer, etc. In some embodiments of the invention the merchant may not offer the product at a discount, but instead the financial institution may subsidize the offer by providing the discount itself. In this instance, the financial institution would pay the merchant the full price of the product at the time of sale, but debit the customer account a discounted price or rebate the customers at some future point in time. The financial institution could make up for the discounts by charging the merchants a fee to display the offer to the customer 6 or by taking payments from the merchant for all of the discounts on offers provided within a certain time period.

Therefore, in some embodiments of the invention, either the merchant or the financial institution will offer customized discounts for each customer 6, which are based in part on the customer's profile data and the customer's transaction history information. As previously discussed the customer profile information could include what accounts the customer 6 has at the financial institution (checking, savings, equity line, etc.), as well as what services the customer 6 uses (such as financial planners, wealth management, etc.). The customer transaction history information could include the purchases the customer 6 has made at various stores, the costs of the purchases, time of year and day they were made, the accounts used to pay for the purchases, etc. In some embodiments, the more products that the merchant uses with the financial institution the greater the discount will be, the more accounts and services the customer 6 uses at the financial institution the greater the discount will be, and the more the customer 6 spends with a particular merchant the greater the discounts will be for that merchant.

The merchant offer program application 10 can determine the amount of the products the customer 6 has with the financial institution through the customer profile information, and can use that information as a basis for making offers available to that customer 6. The amount of business includes but is not limited to, how many accounts the customer has, the amount of money in those accounts, any loans the customer 6 has with the financial institution, any financial services the customer 6 uses, the net present value of the customer with the financial institution, etc. In one embodiment, the more products the customer 6 uses from the financial institution the greater the discount will be. These factors can also be combined with the customer's relationship with various merchants to determine what offers to make available to the customer 6. For example, the merchant offer program application 10 can identify from the customer's transaction history what types of products the customer 6 has purchased from various merchants in the previous week, month, six-months, year, etc. The size of the discounts the customer 6 receives based on the customer's relationship with the merchants may be based on the purchases made by the customer 6 with the merchant, and may vary in real-time or near real time each time a purchase is made or not made. For example, a merchant in some embodiments may want to offer greater discounts to a customer 6 who has not purchased anything in a while in order to try to generate new business. In other embodiments, a merchant may want to reward a loyal customer 6 in order to promote additional purchases. Therefore, in some embodiments the more the customer 6 has purchased in the past, the greater the customer's discount will be.

For example, the financial institution may have relationships with both Company B and Company C, which are one-stop shop stores providing a range of products. A specific TV offered through the merchant offer program application 10 by Company C may sell for ten (10) dollars less than the same TV offered through Company B, based on the financial institution's arrangements it has made with both merchants. However, when the customer 6 is searching for a specific TV (or TVs in general), the financial institution may identify the transactions the customer 6 has made with both businesses, by examining the transaction history information that the financial institution has. If the financial institution, for example, identifies that the customer 6 purchased two-thousand (2,000) dollars in products from Company B in the previous year, the terms of the relationship between the financial institution and Company B may dictate that the financial institution will offer the TV for one-hundred (100) dollars off of the typical price of the TV. Therefore, the customer 6 receives a more attractive price than she would have received because of the customer's relationship with the financial institution and/or the merchant.

In other embodiments of the invention the merchant offer program application 10, provides member offers, such as a list of product discounts, which are offered to all customers 6 of the merchant offer program environment 1. In still other embodiments of the invention, the merchant offer program application 10, provides public offers, such as a list of product discounts that are offered by the merchant to anyone in the public, not just members of the merchant offer program environment 1. Furthermore, customized offers, member offers, or public offers are provided by the merchant offer program application 10 and displayed through the local merchant offer program application 11.

When the merchant offer program application 10 identifies an offer for the customer 6 the local merchant offer program application 11 notifies the customer 6 of the offer, as illustrated by block 212 in FIG. 2A. In one embodiment for example, as illustrated in FIG. 3, a notification indicator 304, such as a dollar sign or other icon or indicator could appear in the bottom of the web browser that the customer is using to view the merchant's website. In other embodiments, the notification indicator 304 could appear in the tool bar at the top or bottom of the web browser or computer screen display, or in other areas of the web browser or computer screen. The dollar sign, or other icon or notification indicator 304, signals to the customer 6 that the merchant offer program application 10 identified an offer in which the customer 6 may be interested that could save the customer 6 money. The offer may be relevant to a product the customer is viewing, it may be responsive to a wish list item, it may be based on just the customer's transaction history and/or profile information, etc.

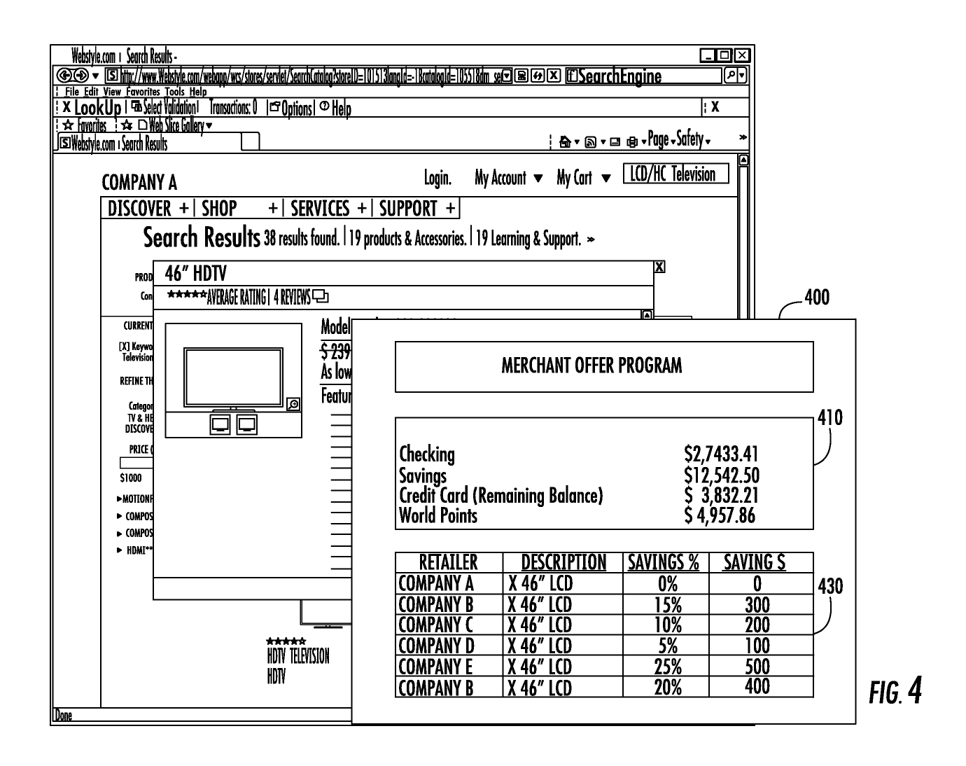

As illustrated in blocks 214 and 216 of FIG. 2B, when the customer 6 selects the notification indicator 304, a pop-up window, such as a local interface 400, or other display is provided on the computer screen, or other device, illustrating the offers identified by the merchant offer program application 10 as shown in FIG. 4. In some embodiments of the invention the customer 6 does not need to select the indicator to view the local interface 400. In some embodiments, the local interface 400 automatically pops-up on the screen when the merchant offer program application 10 identifies an offer. In other embodiments of the invention, when an offer is identified the offer appears within the web-browser or web-browser page that the customer 6 was viewing.

The pop-up window, such as the local interface 400, provides the customer 6 with offers related to products, or content that the customer 6 is currently viewing at an Internet website of a merchant, products listed on the customer's wish list, or products of interest to the customer 6 based on the customer's transaction history and/or customer profile. The offers provided to the customer 6 in the window reflect offers, prices, and discounts from the current merchant or other merchants in which the customer 6 may be interested. The offers can be ranked based on various factors, such as but not limited to the discounts offered, agreements between the merchants and the financial institutions, etc. The offers, in some embodiments will include links, such as to the merchant's web pages, which provide more information about the relevant offers.

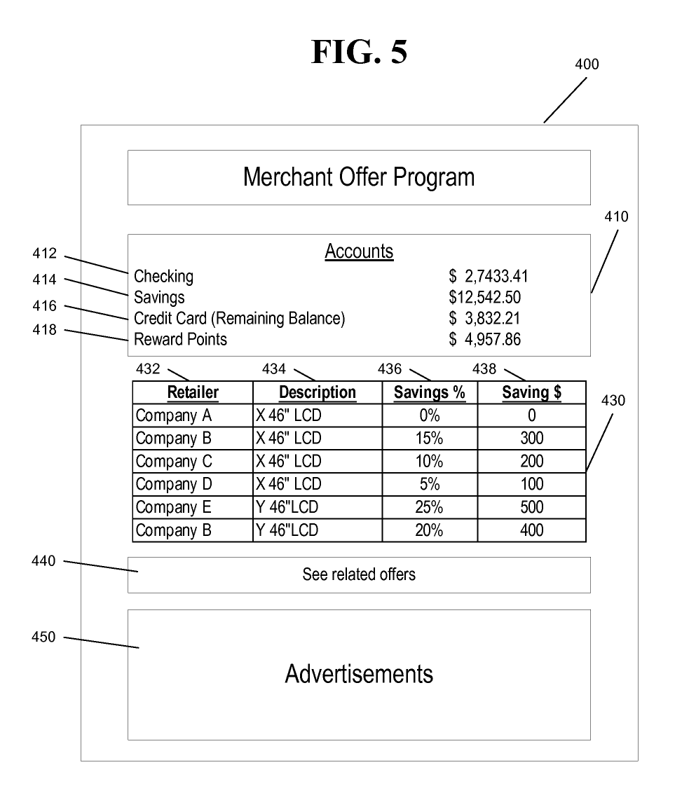

As illustrated in FIG. 5, in an exemplary embodiment of the invention, the local merchant offer program application interface 400 has two sections, the accounts section 410, and the offers section 430. The accounts section 410 illustrates the available balances the customer 6 has in each of the customer's accounts. The merchant offer program application 10 communicates with the local merchant offer program application 11 and the account management applications 30 in the customer account systems 8 to determine and display the account balances in the local interface 400. Other sections that contain other types of information, for instance the customer's monthly budget, etc. can also be displayed in the local interface 400.

The offer section 430, in some embodiments, displays the other retailers 432 that can offer the same or similar product, the offer description 434 illustrating what the offer is (the same product or a similar one), the percent savings 436, and the actual dollar amount savings 438. In other embodiments of the invention the offer section 430, another section, or a separate tab displays related or add-on products in which the customer 6 may be interested. For example, if a customer is searching for a forty-six inch LCD TV the customer may also be interested in DVD players, or services such as satellite TV. In one embodiment of the invention, a “see related offers” section button 440 or tab is selected by the customer 6 in order to view any related offers identified by the merchant offer program application 10, as illustrated in FIG. 5. However, in some embodiments the related offers are displayed in the offer section 430 along with the product for which the customer 6 is searching. In still other embodiments of the invention, the local merchant offer program application interface 400 has an advertisement section 450 that displays one or more targeted advertisements to a customer 6 based on the customer's previous purchasing history, customer profile information, and/or website content that the customer 6 is currently viewing.

As illustrated by block 218 in FIG. 2B, in some embodiments the local interface 400 provides links to websites that contain additional information about the products that are the subject of the offers or related offers in the offers section 430. The customer 6 selects the offer and is then taken to a website, such as the merchant's website, other website, or a display in the local interface 400, which provides more information about the savings provided by the offers. Block 220 in FIG. 2B illustrates that the customer can select the original offer that the customer 6 located or one of the replacements offers that the merchant offer program application 10 identified and displayed to the customer 6.

As illustrated the by block 222 in FIG. 2B the customer 6 can also purchase related products in addition to, or in lieu of, the originally located products or replacement products displayed by the merchant offer program application 10.

In some embodiments, the customer 6 will have to authenticate herself in order for the merchant offer program application 10 to communicate with the account management applications 30, such as the customer's online banking accounts, in order to display the customer's real-time account balances. In other embodiments of the invention, the merchant offer program application 10 estimates the customer's account balances based on what the balances were the last time the customer 6 made a purchase or authenticated herself. In some embodiments of the invention, the local interface 400 displays the account balances for the customer's checking account 412, savings account 414, credit card account 416, and any reward points 418 that the customer has accumulated. In still other embodiments, after the customer 6 makes purchases, the account balances displayed in the local interface 400 are updated in real-time or near real-time in order to show the customer 6 how much money the customer 6 has available in each of her accounts.

In other embodiments of the invention, if the customer 6 grants access, the local merchant offer program application 11 can also display the account information, such as balances, of other accounts or credit cards maintained by outside financial institutions. In these embodiments, the financial institution may have a relationship with the outside financial institutions and/or the customer 6 has supplied the merchant offer program application 10 with access to the outside accounts (i.e. by providing the sign in and password information for online banking services).

After the customer 6 selects the products she wants to purchase, either through the Internet or at a physical store, the merchant offer program application 10 assists the customer in determining how she wants to pay for the products. As illustrated by block 224 in FIG. 2B the customer 6 selects from which account or multiple accounts the customer 6 wants to pay for the offer selected. In some embodiments of the invention the customer's preference for paying for an offer from a particular account or set of accounts is stored in the customer profile information in the merchant offer program application 10, and in such circumstances, the predetermined preference acts as a default. In some embodiments of the invention, the necessary financial and shipping information is pre-populated at check-out when the customer 6 makes a purchase. In other embodiments of the invention, the customer 6 is prompted at checkout as to how the customer wants to pay for the products selected. In such embodiments, a list of the customer's accounts are provided in the local interface 400 or in another pop-up window. While the financial institution will pay the merchant the full amount of the offers or the discounted amounts, in some embodiments the customer can tell the financial institution how to apply the cost of the products to the customer's accounts. For example, the customer for one purchase may indicate that she wants to pay 20% from her checking account and 80% from her savings account. The amounts and the various accounts can be changed for every purchase made. The decision of what account or accounts are used to make payments can be made in some embodiments at the time of purchase. In other embodiments of the invention, the customer 6 has a period of time to determine what account or accounts are debited. In such embodiments of the invention, the customer 6 logs into her online banking, merchant offer program, or other account and, either at the time of purchase or at some later time, associates particular transactions and transaction amounts with particular accounts.

In some embodiments of the invention, the financial institution effectively becomes a clearing house for any of the transactions made between the customer 6 and the merchant. After the customer 6 authenticates herself as an actual customer of the financial institution, in some embodiments the financial institution guarantees payment to the merchant for the products. The financial institution is able to determine in each instance whether it wants to assume the risk for the transaction based on information the financial institution has for each of its customers. This is a benefit over independent credit card issuers because these companies do not know the financial well-being of one their customers outside of the customers' credit card balances, payment histories, and/or credit score. In this respect, the merchant offer program application 10 can be utilized to help customers from over spending their means and can assist the financial institution in managing risks attendant to extending consumer credit.

The actual purchase of the selected products from the merchant through the merchant offer program environment 1 is achieved in a number of ways. For example, in one embodiment of the invention, the links for particular offers in the local interface 400 take the user to the merchant's secure website. However, in other embodiments of the invention, the links take the customer 6 to the public merchant website and the financial institution can pre-populate the account information, as well as the mailing information. In other embodiments of the invention, the account information can be a preapproved single use account number provided by the financial institution, which ties the customer 6 to the customer's accounts at the financial institution, without disclosing the customer's real account information to the merchant. In those instances where the financial institution has a pre-existing relationship with the applicable merchant, the transaction that takes place can be virtually instantaneous. The financial institution can credit the account of the merchant, if the merchant has an account at the financial institution, or in other embodiments of the invention, the financial institution can electronically transfer the money to the merchant. Alternatively, the financial institution can credit the merchant for the customer's purchase on a schedule that is prearranged and agreed to by the financial institution and merchant.

After the payment method is satisfied, either the customer 6 or the financial institution can transfer the shipping address of the customer 6 to the merchant for shipping the product or providing the service. In lieu of the merchant shipping a product to the customer 6, the customer 6 can pick-up the product at the store. Alternatively, if the customer is making the purchase at a brick and mortar location the customer 6 can simply pick-up the product when purchased.

In other embodiments of the invention, the financial institution provides various financing options for the customer 6 to use in paying for the selected products. For example, the financial institution can allow the customer to make a purchase from a merchant, but not debit the customer's account or accounts for 30, 60, 90, etc. days. As is the case with the amount of discounts provided to various customers 6, different financing options can be provided to customers depending, in some embodiments for example, on the customer's standing with the financial institution and the number of financial of products the customer uses with the financial institution.

Likewise, with respect to the financial institution making payments to a merchant, there are a number of options available to complete the transition as far as the merchant is concerned. In some embodiments of the invention, the payment system and process provides settlement options to the merchant, such as real-time, 3-day, 15-day, etc. The merchants can be charged different types of fees, or no fees, depending on what payment options the merchants require. Different options may apply in different circumstances. For instance, a different settlement option might apply to different products sold by the merchant depending upon the merchant's payment obligations to its suppliers. In other embodiments, the payment options may vary depending upon the merchant's financial situation, need for cash flows, lines of credit etc. The payment option variables are monitored electronically by the financial institution, and the appropriate payment option can be selected automatically based on a series of rules in the merchant offer program application.

In some embodiments of the invention the steps in blocks 204 to 224 are repeated every time the customer 6 visits a new web-site, selects a different product from the web-site the customer 6 is currently viewing, or when the merchant offer program application 10 identifies a product for the customer 6 based on the customer's wish list, transaction history, or customer profile.

After a customer 6 selects a product, replacement, or add-on to purchase, the merchant offer program application 10, in some embodiments of the invention, provides online social networking opportunities. For example, the customer 6 can rate a specific offer, merchant, or discount program. In other embodiments of the invention, the customer 6 can display in the local interface 400 the most popular offers as rated by other customers who have accepted the offer. Furthermore, in other embodiments of the invention the customer 6 can suggest to other customers a purchase or discount, that the customer 6 made, by sending an e-mail, instant message notification, text message, or other notification through a messaging service in the merchant offer program application 10 or through other standard messaging formats using the merchant offer program application 10. In other embodiments of the invention, the customer may join social networks or groups through the merchant offer program application 10, which allow the customer 6 and other members of the groups to receive special offers that only members of the specific group can receive and use.

In addition to displaying add-on products, while the customer 6 is searching for specific products on the Internet, the merchant offer program application 10 will also make add-on product suggestions after the customer has purchased a product through the merchant offer program application 10. In some embodiments of the invention some types of add-ons can only be made after a particular offer is accepted and purchased by the customer 6. For example, an extended warranty for a particular product such as a forty-six inch Company A television offered through a merchant is only available for purchase through that merchant if the actual product is purchased through that merchant. These additional add-ons, in some embodiments, can be displayed to the customer 6 through the local merchant offer program application interface 400, after the customer 6 has purchased a particular product. In other embodiments of the invention the add-ons are sent to the customer 6 though e-mail, text message, instant message, or other like form of communication. In other embodiments of the invention, some add-ons are provided by the merchant offer program application 10 and are based, in part, on product type. For example, when a blue-ray DVD player is purchased the add-ons will include Blue-ray DVDs as opposed to regular DVDs, because the customer would not likely want Blue-ray DVDs if she purchased a regular DVD player.

In some embodiments of the invention the merchant offer program application 10 has a search feature that allows a customer to search for available offers, through the local merchant offer program application 11, by product (i.e. SKU, model, etc.), merchant, product type, brand, manufacturer, price, discount price, location, etc. The discounts provided to the customer 6 during the search can be customized for each individual user based on relationships between the financial institution and merchants, the customer's profile information, the customer's transaction history, and/or publicly available discounts. The offers from the search, in some embodiments, are prioritized based on the customer's location, transaction history, profile information, etc.

In some embodiments of the invention the customer might not be able to find the particular product for which the customer 6 is searching because the product is out of stock or the service is booked, the product is too expensive for the customer 6, the product cannot be delivered in time, etc. In such cases, the merchant offer program application 10 provides the customer 6 the ability to add a particular desired product to a wish list. The customer's individual wish list, in some embodiments, has one or more products that have notification alerts attached to them. The notification alerts inform the merchant offer program application 10 to watch for offers for those specific products, and any discounts related to them. The customer can also add merchants to the wish list in order to be notified when a specific merchant is providing discounts to customers.

When the merchant offer program application 10 identifies the availability of a product that is on the customer's wish list, the merchant offer program application 10 notifies the customer. For example, the customer can identify a specific product, such as a forty-six inch TV, and/or a specific price for the product, such as one-thousand three-hundred (1,300) dollars for the forty-six inch TV. The merchant offer program application 10 monitors the databases 19 in the merchant offer program system 3, or in some embodiments searches the Internet, for the product that meets the particular parameters that the customer 6 wants. The merchant offer program application 10 notifies the customer 6 when one or more merchants meet the customer's parameters. In other examples, the customer 6 can identity a specific merchant, such as Company B, or a specific type of product, such as a flat screen TV, and request that the merchant offer program application 10 notify the customer when the merchant is having a sale, or when sales are occurring for that type of product. In this way the customer 6 does not have to continuously search for a product. Instead, the customer 6 lets the merchant offer program application 10 identify the product for the customer 6, and then receives a notification when the particular product is identified.

In some embodiments of the invention the customer 6 can be notified of products, coupons, advertisements, reward cards or points from a merchant, etc., by the merchant offer program application 10 when the customer is not even searching the web for a specific offer. The merchant offer program application 10, in some embodiments, uses the customer's wish list, or the customer's profile data and transaction history, to notify the customer when one or more merchants are offering a particular product in which the customer 6 might be interested. In one embodiment of the invention, the offers found by the merchant offer program application 10 are sent to the user though various communication channels, such as, but not limited to e-mail, text messages, financial institution statements, on receipts for purchases online or at brick and mortar institutions, or ATM transactions, etc.

In some embodiments of the invention, the financial institution can monitor each customer's savings realized and not realized by using or not using the merchant offer program application 10. A system and process is used for determining and displaying to customers 6 the amount of money saved, including, but not limited to percentages saved, total savings, what could have been saved, etc. The merchant offer program application 10, either online, though the local merchant offer program application 11 or online banking, or through paper statements, illustrates the amount of money the user saved or could have saved by using the merchant offer program application 10 on both a total basis over a specified time period, as well as on a transaction-by-transaction basis. In other embodiments of the invention, the amount saved if the customer 6 would have enrolled in more financial institution products could also be illustrated online or in paper statements. Also in some embodiments of the invention, discounts, e-coupons, merchants, etc. can be suggested for future purchases through the online or paper statements.

In other embodiments of the invention the merchant offer program application 10 is accessed though and runs inside one or more of the account management applications 30, such as an online banking application. For example, in some embodiments the customer 6 logs onto the customer's online banking accounts and searches for offers through the online banking account application. The merchant offer program application 10, acting through the online banking account application, provides offers, such as discounts, coupons, rebates, rewards, etc. to the customer 6 as previously discussed. However, in this embodiment the offers are displayed though the online banking application not through a separate local merchant offer program application 11 that was downloaded to the customer computer systems 4. Therefore, in this embodiment, the customer 6 could use the merchant offer program application 10 on any computer because the merchant offer program application 10 and local merchant offer program application 11 are run through an online banking application and are not tied to a customer's specific computer system 4.

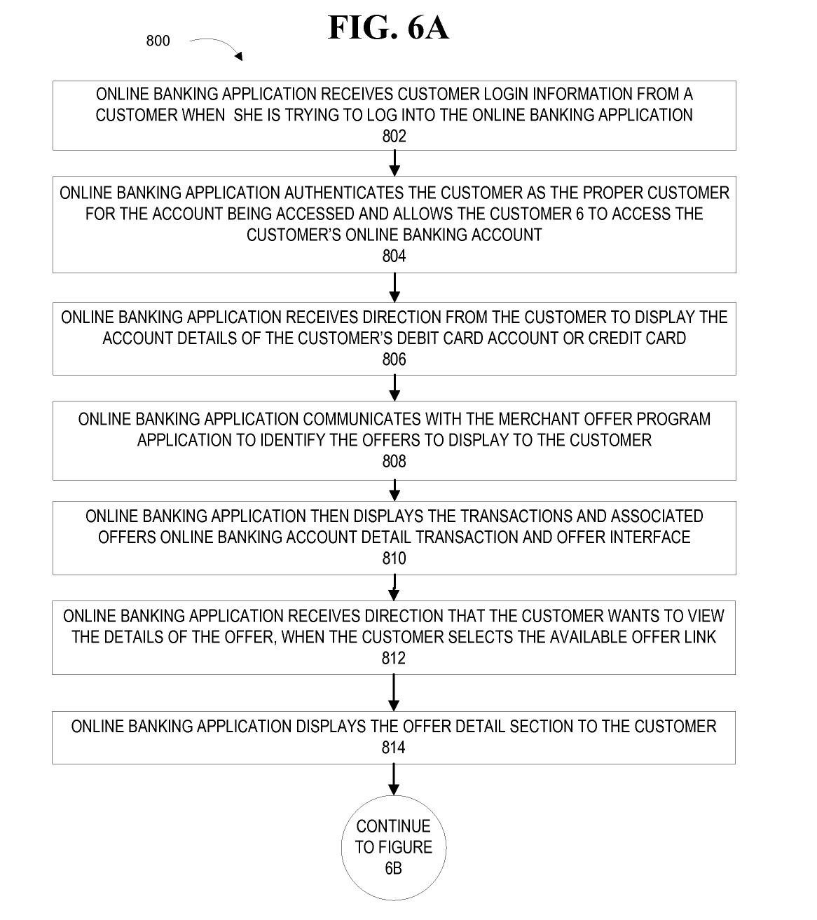

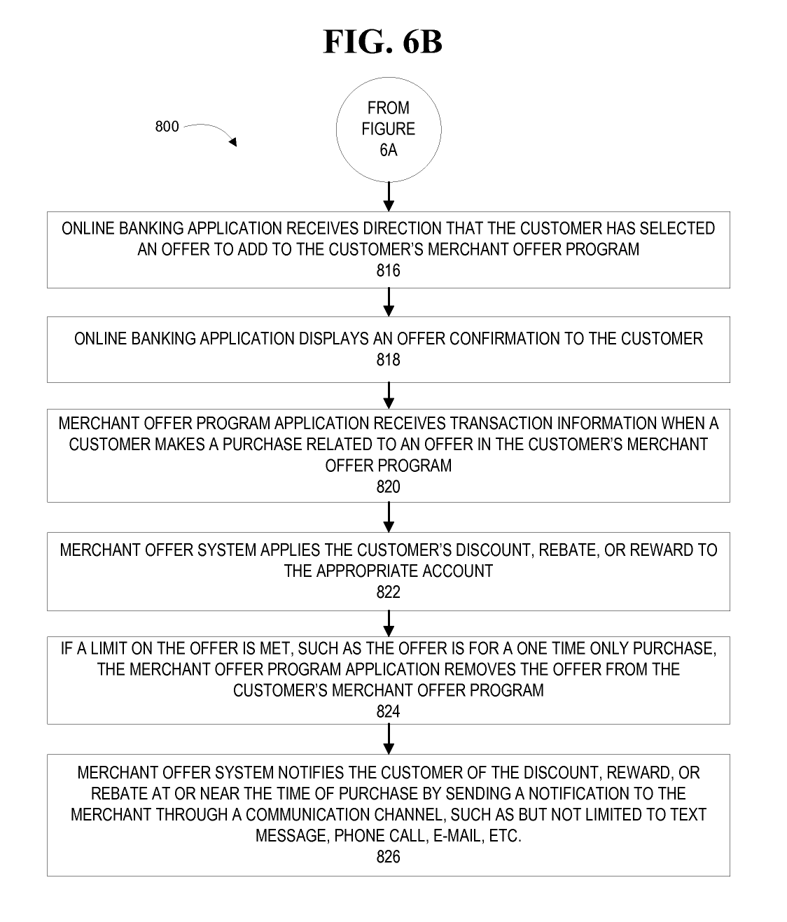

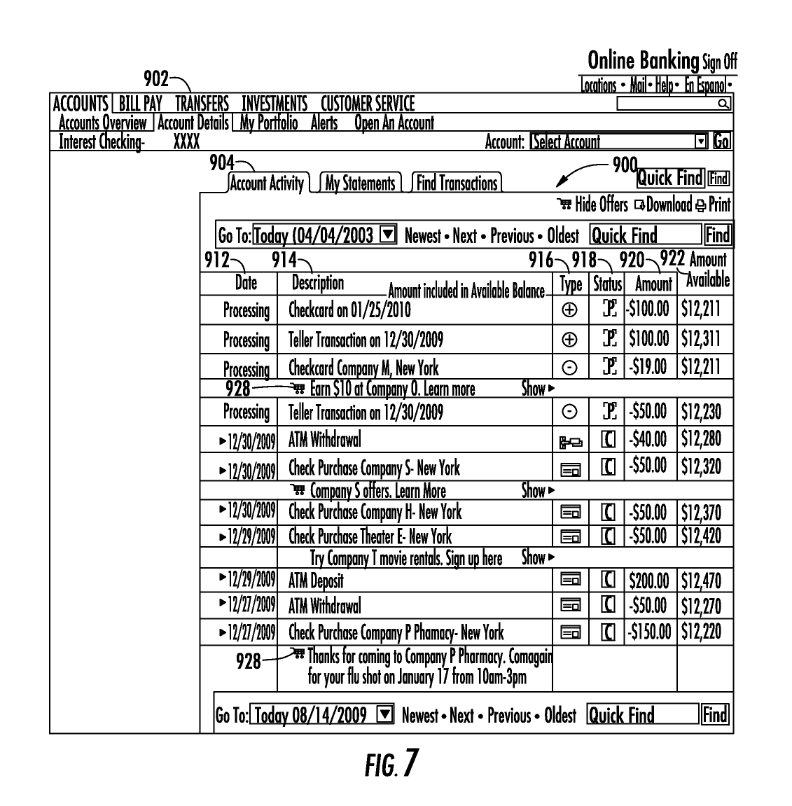

In one embodiment of the invention the merchant offer program is used in connection with the online banking application to present offers to customers 6. Customers 6 can select to add the offers to the customer's merchant offer program directly within the customer's online banking account through the online banking application. FIGS. 6A and 6B illustrate an online banking and customer shopping process 800 in accordance with an embodiment of the present invention. As illustrated by block 802, the online banking application receives customer login information from a customer 6 when a customer is trying to log into the online banking application. Thereafter, as illustrated in block 804 the online banking application authenticates the customer 6 as the proper customer 6 for the account being accessed and if the customer is authenticated allows the customer 6 to access the customer's online banking account. As illustrated by block 806, the online banking application receives direction from the customer 6 to display the account details of the customer's debit card account or credit card account. The online banking application communicates with the merchant offer program application 10 to identify the offers to display to the customer 6 based on the customer's account profile, the customer's transaction history, and/or the customers relationships with merchants and the financial institution as previously described herein, as illustrated by block 808. As illustrated by block 810, the online banking application then displays the online banking account detail transaction and offer interface 900 in the account details tab 902 and account activity tab 904, in accordance with an embodiment of the present invention, as illustrated in FIG. 7. The transaction and offer interface 900 displays the customer's past transactions, as well as any offers identified by the merchant offer program application 10 in the transaction and offer section 910. The transaction and offer interface 900 displays the transaction date 912, description 914, type 916, status 918, amount 920, and available balance 922 for the transactions the customer 6 has made using a debit card or a credit card of the financial institution. The online banking application displays available offers 928 to the customer under various transactions. In some embodiment the available offer 928 is listed under a particular transaction for a company and can be related to the same company, another company, substitute product, and/or related product. As illustrated in FIG. 7, for example the customer made a transaction with Company M, and is offered by the merchant offer program through the online banking application an offer from Company O.

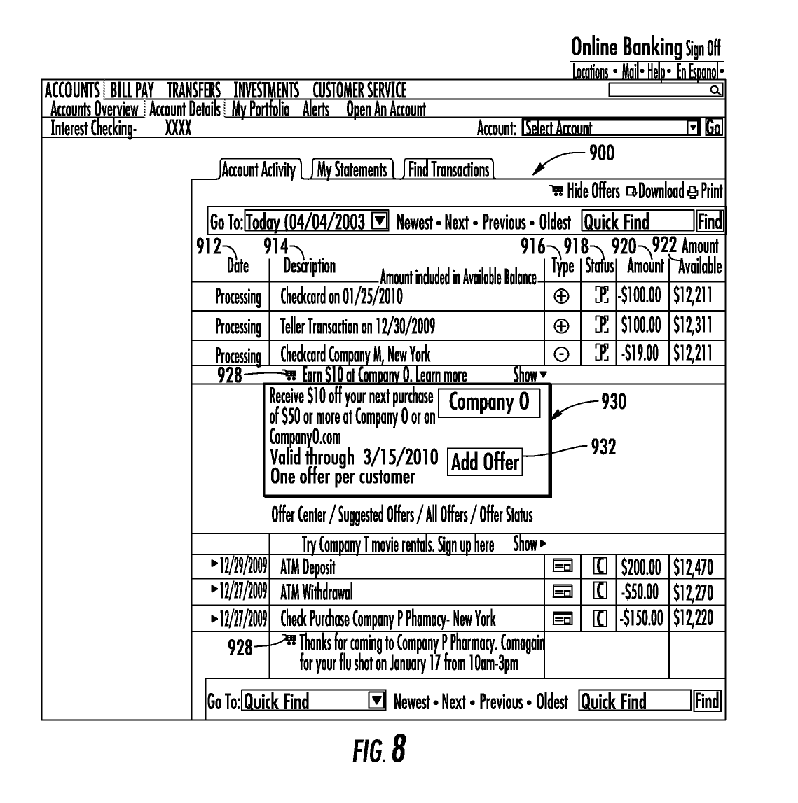

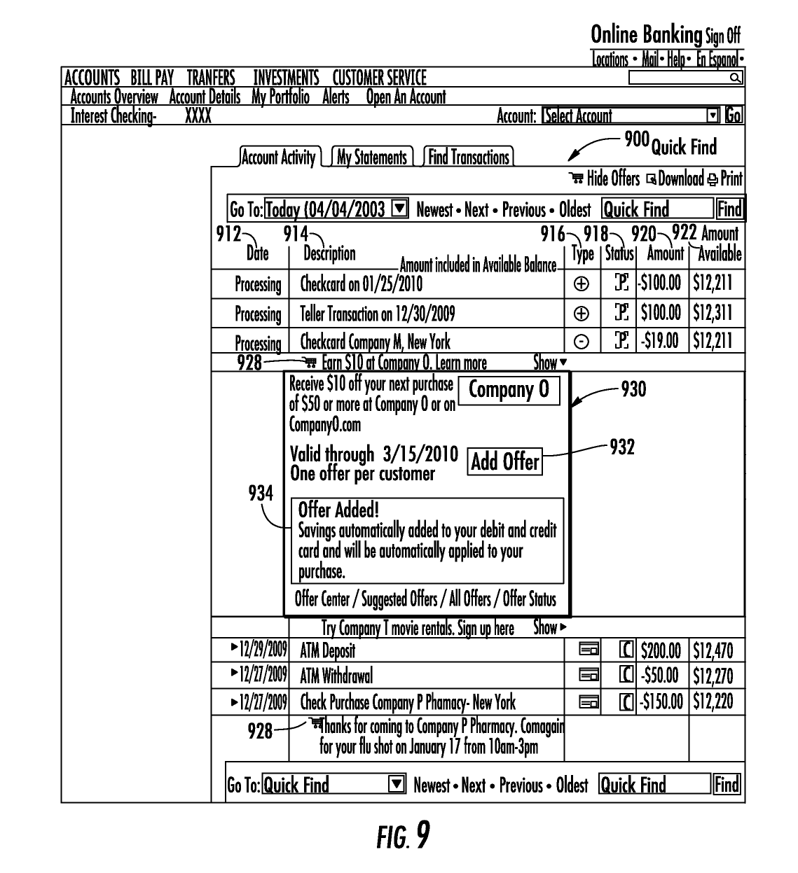

As illustrated in block 812 in FIG. 6A, the online banking application receives direction that the customer 6 wants to view the details of the offer, for example when the customer selects the link for the available offer 928. Thereafter, as illustrated in block 814, the online banking application displays the offer detail section 930 to the customer 6, as illustrated in FIG. 8. The offer detail section 930, in some embodiments describes the offer, lists the expiration date if applicable, and/or describes any purchasing limits on the offer, such as a minimum purchase limit, etc. The offer detail section 930 has an add offer button 932, that the customer 6 can select to add the available offer 928 to the customer's merchant offer program, as illustrated by block 816 in FIG. 6B. As illustrated by block 818 in FIG. 6B, after receiving direction to add the available offer 928 to the customer's merchant offer program the online banking application displays an offer confirmation 934 to the customer 6 in the offer detail section 930, as illustrated in FIG. 9.

After the customer 6 adds the offer to the customer's merchant offer program, the customer 6 can use the offer at a later date. When the customer makes a purchase with the customer's debit card or credit card at the store or online for a product that meets the offer limits the merchant offer program receives transaction information from the merchant systems 9, as illustrated by block 820 in FIG. 6B. In some embodiments the discount is applied directly at the point of sale, either at the register at the store or online over the Internet. However, in other embodiments, the customer pays the retail price for the product and then the offer, such as a discount, rebate, or reward, is applied to the customer's account by the financial institution at the time of sale or sometime thereafter. In some embodiments of the invention, the customer 6 can direct to which account the customer 6 wants the discount, rebate, or reward applied. As illustrated by block 822, the merchant offer system applies the customer's discount, rebate, or reward to the appropriate account. In some embodiments, if the limit on the offer is met, such as the offer is for only a one time purchase, the merchant offer program application 10 removes the offer from the customer's merchant offer program, as illustrated by block 824. In some embodiments of the invention the merchant offer system notifies the customer of the discount, reward, or rebate at or near the time of purchase by sending a notification to the merchant through a communication channel, such as but not limited to text message, phone call, e-mail, etc., as illustrated in block 826

The merchant applications 40, in some embodiments, allow the merchants to access the merchant offer program application 10 over the network 2 through the merchant offer program system 3. The merchant offer program application 10, in some embodiments, has a merchant interface that the financial institution uses to mange the merchant network by only allowing access to the merchant interface to specific merchants that the financial institution has certified for inclusion into the merchant offer program environment 1. The merchant interface allows a merchant to enter offers into the merchant offer program application 10 that are available to all customers 6, groups of customers 6, or individual customers 6 based on customer demographic information. In some embodiments, the merchant interface also allows a merchant to monitor its offers, such as the status and success of its offers.

The financial institution will first determine what merchants to certify for access to the merchant offer program application 10. In some embodiments, the merchant must meet quality standards set by the financial institution before the merchant is certified. In some embodiments, the quality standards include the financial stability of the merchant, customer ratings of the merchant, supplier and distributor ratings of the merchant, product delivery time, payment timeliness, etc. These factors can be determined by the financial institution through a number of different channels. For example the merchant financial stability could be determined from the accounts the merchant has with the financial institution, other financial institutions, or outside rating agencies. Customer, supplier, or distributor ratings of the merchant can be determined from consumer advocacy groups, or other rating organizations that the financial institution uses or with which the financial institution has partnered.

After the financial institution certifies the merchants for access to the merchant interface, the financial institution provides the merchants with user names and passwords or other merchant authentication mechanisms that allow the merchant to access the merchant interface through the merchant offer program application 10. Thereafter, the merchant can access the merchant interface and authenticate that the financial institution has certified that the merchant can access the merchant offer program application 10. The authentication mechanisms also indicate to the financial institution that the current user has authority to create and/or monitor offers for the particular merchant. The merchant can then begin to enter offers for the financial institution's customers 6.

In some embodiments the merchant can create, modify, and control the offers in the merchant applications 40 and upload the offers to the merchant offer program application 10. In other embodiments of the invention the merchant can create the offers directly in the merchant offer program application 10, through the merchant interface.

In some embodiments of the invention, when entering offers into the merchant offer program application 10 the merchant can set various preferences associated with a product, such as, but not limited to, a specific price or price range for which the merchant is willing to sell a product, a discount percentage to offer, identification of products or types of products to which to apply the offer, how long the offer will be available to customers, if the offer changes over time, if additional discounts apply to the product, etc. For example, to name a few, the merchant may set a particular price for a product, which will gradually decline in price automatically every month. The merchant may indicate that an offer is only good for a month. The merchant may also indicate that a product will have an additional discount if the customer purchases other products from the merchant at the same time. The merchant may offer credits or rebates to all the customers who purchase a product, if there are a specified number of sales of the product.

In some embodiments of the invention, the merchant can also set which customers 6 should receive the offers based on customer demographic information, such as, but not limited to age, geographic location, customer purchasing history, groups or clubs the customer is associated with, etc. For example, some offers may apply to all of the customers 6 in the merchant offer program application. However, some offers may only apply to customers 6 who live in a particular state, region, or other location. The merchant may limit offers to individual customers 6 who have spent a specific amount of money with the merchant in the past, or who have purchased a specific product from the merchant over a specific time frame. The merchant may also limit certain offers to customers 6 who are members of an affinity program.

The offers entered into the merchant offer program application 10 can be provided to customers 6 in real-time, or in other embodiments can be set to take effect at a later date in the future or not until the financial institution has approved the offer submitted by the merchant. The merchant has the ability, in some embodiments, to update the offers that they entered into the merchant offer program application 10 anytime to try to influence sales of various products. However, in some embodiments, some offers may not be able to be changed for a period of time once they are inputted into the system.

Since the financial institution is providing a service to its customers 6 by providing offers to the customers 6 from various merchants, any merchants who are not providing adequate customer service reflect negatively on the financial institution. Therefore, not only does the financial institution have the ability to manage the merchants in the merchant offer program environment 1 by determining what merchants are allowed into the merchant offer program environment 1, but they also have the ability to remove merchants from the merchant offer program environment 1. In some embodiments, the financial institutions can make periodic reviews of merchants that have been certified, in order to make sure the merchants are still financially stable, or have received positive customer feedback.

In some embodiments, the merchant interface allows the merchant to monitor current offers. For example, the merchant interface may create charts, graphs, tables, and/or other statistics for the merchant and display these to the merchant when the merchant logs into the merchant interface. These statistics may relate to particular offers and the success thereof, such as how often they are displayed to potential customers, how often they are accepted, the amount of money being made or discounted, and/or the like. The statistics may also provide an overview of the success of the overall relationship with the financial institution and use of the merchant offer program application 10.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A system for providing merchant offers, comprising:
a memory device;
a communication device; and
a processing device operatively coupled to the memory device and the communication device, wherein the processing device is configured to execute computer-readable program code to:
receive content information related to content in which a customer is interested;
access account information for the customer from a customer account at an institution;
determine an offer for the customer based at least in part on the content information received and the account information from the institution; and
provide the offer to the customer at a customer computer system.

2. The system of claim 1, wherein the content information related to content in which the customer is interested is content that the customer is viewing over the Internet.

3. The system of claim 1, wherein the content information is related to a good or a service provided by a merchant.

4. The system of claim 1, wherein the offer is for a discount, a coupon, a promotion, an add-on sale, an upsell, a rebate, an advertisement, or marketing information related to the content in which the customer is interested.

5. The system of claim 1, wherein the account information comprises customer transaction information from the institution.

6. The system of claim 1, wherein the account information comprises customer profile information from the institution.

7. The system of claim 1, wherein the account information comprises relationship information between the customer and the institution.

8. The system of claim 1, wherein the account information comprises relationship information between the customer and a merchant providing the product associated with the offer.

9. The system of claim 1, wherein the processing device configured to execute computer-readable program code to determine an offer for the customer is also based at least in part on relationship information between the institution and a merchant providing the product associated with the offer.

10. The system of claim 1, wherein the processing device is configured to execute computer-readable program code to:
receive notification from the customer that the customer is interested in the offer.

11. The system of claim 1, wherein the processing device is configured to execute computer-readable program code to:
display the offer on an interface at the customer computer system.

12. The system of claim 1, wherein processing device is configured to execute computer-readable program code to:
display at least one account balance on an interface at the customer computer system for the customer account.

13. The system of claim 1, wherein the processing device is configured to execute computer-readable program code to:
receive a selection of the offer indicating that the customer wants to enter into a transaction.

14. The system of claim 1, wherein the processing device is configured to execute computer-readable program code to:
receive a selection of the customer account that the customer wants to use to make a transaction related to the offer.

15. The system of claim 1, wherein the institution is a financial institution.

16. The system of claim 1, wherein the processing device configured to execute the computer-readable program code comprises executing the computer-readable program code of a merchant offer program application.

17. The merchant offer program system of claim 16, wherein at least a portion of the merchant offer program application is stored in a first memory device associated with the institution; and wherein the processing device configured to execute the computer-readable program code of the portion of the merchant offer program application stored in the first memory device associated with the institution is a first processing device associated with the institution.

18. The merchant offer program system of claim 16, wherein the at least a portion of the merchant offer program application is stored in a second memory device associated with the customer computer system; and wherein the processing device configured to execute the computer-readable program code of the portion of the merchant offer program application stored in the second memory device associated with the customer computer system is a second processing device associated with the customer computer system.

19. A computer program product for a merchant offer program system, the computer program product comprising at least one non-transitory computer-readable medium having computer-readable program code portions embodied therein, the computer-readable program code portions comprising:
an executable portion configured for receiving content information related to content in which a customer is interested;
an executable portion configured for accessing account information for the customer from a customer account at an institution;
an executable portion configured for determining an offer for the customer based at least in part on the content information received and the account information from the institution; and
an executable portion configured for providing the offer to the customer at a customer computer system.

20. The computer program product of claim 19, wherein the content information related to content in which the customer is interested is content that the customer is viewing over the Internet.

21. The computer program product of claim 19, wherein the content information is related to a good or a service provided by a merchant.

22. The computer program product of claim 19, wherein the offer is for a discount, a coupon, a promotion, an add-on sale, an upsell, a rebate, an advertisement, or marketing information related to the content in which the customer is interested.

23. The computer program product of claim 19, wherein the account information comprises customer transaction information from the institution.

24. The computer program product of claim 19, wherein the account information comprises customer profile information from the institution.

25. The computer program product of claim 19, wherein the account information comprises relationship information between the customer and the institution.

26. The computer program product of claim 19, wherein the account information comprises relationship information between the customer and a merchant providing the product associated with the offer.

27. The computer program product of claim 19, wherein the executable portion configured for determining the offer comprises determining the offer based at least in part on relationship information between the institution and a merchant providing the product associated with the offer.

28. The computer program product of claim 19, further comprising an executable portion configured for receiving notification from the customer that the customer is interested in the offer.

29. The computer program product of claim 19, further comprising an executable portion configured for displaying the offer on an interface at the customer computer system.

30. The computer program product of claim 19, further comprising an executable portion configured for displaying at least one account balance on an interface at the customer computer system for the customer account.

31. The computer program product of claim 19, further comprising an executable portion configured for receiving a selection of the offer indicating that the customer wants to enter into a transaction.

32. The computer program product of claim 19, further comprising an executable portion configured for receiving a selection of the customer account that the customer wants to use to make a transaction related to the offer.

33. The computer program product of claim 19, wherein the institution is a financial institution.

34. A method for using an integrated merchant offer program for customer shopping, the method comprising:
receiving content information related to content in which a customer is interested;
accessing account information for the customer from a customer account at an institution;
determining an offer for the customer based at least in part on the content information received and the account information from the institution, through the use of a processing device; and
providing the offer to the customer at a customer computer system.

35. The method of claim 34, wherein the content information related to content in which the customer is interested is content that the customer is viewing over the Internet.

36. The method of claim 34, wherein the content information is related to a good or a service provided by a merchant.

37. The method of claim 34, wherein the offer is for a discount, a coupon, a promotion, an add-on sale, an upsell, a rebate, an advertisement, or marketing information related to the content in which the customer is interested.

38. The method of claim 34, wherein the account information comprises customer transaction information from the institution.

39. The method of claim 34, wherein the account information comprises customer profile information from the institution.

40. The method of claim 34, wherein the account information comprises relationship information between the customer and the institution.

41. The method of claim 34, wherein the account information comprises relationship information between the customer and a merchant providing the product associated with the offer.

42. The method of claim 34, wherein determining the offer comprises determining the offer based at least in part on relationship information between the institution and a merchant providing the product associated with the offer.

43. The method of claim 34, further comprising receiving notification from the customer that the customer is interested in the offer.

44. The method of claim 34, further comprising displaying the offer on an interface at the customer computer system.

45. The method of claim 34, further comprising displaying at least one account balance on an interface at the customer computer system for the customer account.

46. The method of claim 34, further comprising receiving a selection of the offer indicating that the customer wants to enter into a transaction.

47. The method of claim 34, further comprising receiving a selection of the customer account that the customer wants to use to make a transaction related to the offer.

48. The method of claim 34, wherein the institution is a financial institution.
